(19) United States
(12) Patent Application Publication
(10) Pub. No.: US 2024/0091971 A1
(43) Pub. Date: Mar. 21, 2024

(54) APPARATUS AND METHOD FOR INSPECTING AND PUNCHING A DIFFUSION LAYER FOR WATER ELECTROLYSIS

(71) Applicants: HYUNDAI MOTOR COMPANY, Seoul (KR); KIA CORPORATION, Seoul (KR)

(72) Inventors: Pil Young Lee, Yongin-si (KR); Young June Park, Yangpyeong-gun (KR)

(73) Assignees: HYUNDAI MOTOR COMPANY, Seoul (KR); KIA CORPORATION, Seoul (KR)

(21) Appl. No.: 18/212,386

(22) Filed: Jun. 21, 2023

(30) Foreign Application Priority Data
Sep. 21, 2022 (KR) 10-2022-0119484

(51) Int. Cl. B26D 7/27; G01B 11/06; G01N 15/08

(52) U.S. Cl. CPC B26D 7/27; G01B 11/06; G01N 15/08; C25B 1/04

(57) ABSTRACT

An apparatus and a method for inspecting and punching a diffusion layer for water electrolysis are provided. The apparatus includes a first inspector that inspects a thickness of a diffusion layer for water electrolysis, a second inspector that inspects porosity of the diffusion layer for water electrolysis, and a cutting machine that inspects pore uniformity of the diffusion layer for water electrolysis and cuts the diffusion layer for water electrolysis based on the result of inspecting at least one of the thickness, the porosity, the pore uniformity, or a combination thereof.

### CROSS-REFERENCE TO RELATED APPLICATION

This application claims the benefit of and priority to Korean Patent Application No. 10-2022-0119484, filed in the Korean Intellectual Property Office on Sep. 21, 2022, the entire contents of which are incorporated herein by reference.

### FIELD

The present disclosure relates to an apparatus and a method for inspecting and punching a diffusion layer for water electrolysis.

### BACKGROUND

The statements in this section merely provide background information related to the present disclosure and may not constitute prior art.

An anode (or a negative pole) in a polymer electrolyte membrane water electrolysis (PEMWE) system is subjected to harsh conditions (e.g., a high potential and an acidic environment). Because an anode potential of the PEMWE system is greater than or equal to about 1.8 V, it is higher than a corrosion potential of carbon, which is 0.207 V. Thus, a porous transport layer (PTL) with a titanium material rather than an existing gas diffusion layer (GDL) with a carbon material is applied to the anode.

When the slurry is molded while not uniformly mixed in a PTL manufacturing process or when a temperature deviation occurs at a specific location in a heat treatment process, different rates of heat shrinkage occur, resulting in defective products with large pores with non-uniform pore sizes.

However, it is impossible to visually identify quality deviations in pore size. PTLs should be examined using a microscope or scanning electron microscope (SEM) equipment. It is practically difficult to observe a large number of PTLs required for stacking one stack using an optical microscope or the SEM equipment, because it takes considerable time, man per hour (M/H), and cost.

Furthermore, the PTL varies in performance according to its porosity. For example, when the porosity is low, an ohmic overpotential decreases, but a mass transport overpotential increases. When the porosity is high, the ohmic overpotential increases, but mass transport overpotential decreases.

### SUMMARY

The present disclosure has been made to solve the above-mentioned problems occurring in the prior art while advantages achieved by the prior art are maintained intact.

An aspect of the present disclosure provides an apparatus and a method for inspecting and punching a diffusion layer for water electrolysis to inspect a thickness, porosity, and pore uniformity of the diffusion layer for water electrolysis and may punch the diffusion layer for water electrolysis depending on the inspected result.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, an apparatus for inspecting and punching a diffusion layer for water electrolysis may include: a first inspector that inspects a thickness of the diffusion layer for water electrolysis, and a second inspector that inspects porosity of the diffusion layer for water electrolysis, The apparatus further includes a cutting machine that inspects pore uniformity of the diffusion layer for water electrolysis and cuts the diffusion layer for water electrolysis based on the result of inspecting at least one of the thickness, the porosity, the pore uniformity, or a combination thereof.

The diffusion layer for water electrolysis may be a porous transport layer (PTL) with a titanium material.

The first inspector may include a radiation device that radiates visible light or infrared light at a predetermined spacing and an optical receiver that receives the visible light or the infrared light and may measure a location where the visible light or the infrared light is received by the optical receiver.

The second inspector may measure a weight of the diffusion layer for water electrolysis, and calculate a weight of the diffusion layer for water electrolysis based on an area of a weighing surface, the thickness, a density of material of the diffusion layer for water electrolysis. The second inspector may calculate the porosity using the calculated weight and the measured weight.

The apparatus may further include a marker that marks the result inspected by the first inspector, the second inspector, or a combination thereof on one end surface of the diffusion layer for water electrolysis.

The cutting machine may inspect a uniform degree of a pore size of the diffusion layer for water electrolysis using light where light radiated to the diffusion layer for water electrolysis passes through the diffusion layer for water electrolysis.

When the pore uniformity is within a predetermined design numerical range, the cutting machine may punch the diffusion layer for water electrolysis to a predetermined target size, and if when the pore uniformity is out of the predetermined design numerical range, the cutting machine may not punch the diffusion layer for water electrolysis.

According to another aspect of the present disclosure, a method for inspecting and punching a diffusion layer for water electrolysis may include: inspecting at least one of a thickness of a diffusion layer for water electrolysis, porosity of the diffusion layer for water electrolysis, pore uniformity of the diffusion layer for water electrolysis, or a combination thereof; and cutting the diffusion layer for water electrolysis based on the result of inspecting the at least one of the thickness, the porosity, the pore uniformity, or the combination thereof.

The diffusion layer for water electrolysis may be a porous transport layer (PTL) with a titanium material.

The inspecting may include radiating visible light or infrared light at a predetermined spacing and measuring a location where the visible light or the infrared light is received.

The inspecting may include: measuring a weight of the diffusion layer for water electrolysis; calculating a weight of the diffusion layer for water electrolysis based on an area of a weighing surface, the thickness, a density of material of the diffusion layer for water electrolysis; and calculating the porosity using the calculated weight and the measured weight.

The method may further include marking the result of inspecting at least one of the thickness, the porosity, or a combination thereof on one end surface of the diffusion layer.

The inspecting may include radiating light to the diffusion layer for water electrolysis and inspecting a uniform degree of a pore size of the diffusion layer for water electrolysis using light passing through the diffusion layer for water electrolysis.

### BRIEF DESCRIPTION OF THE DRAWINGS

The above and other objects, features and advantages of the present disclosure should be more apparent from the following detailed description taken in conjunction with the accompanying drawings:

FIG. 1 is a drawing illustrating a structure of a PEMWE cell associated with the present disclosure;

FIG. 2 is a drawing illustrating a configuration of an apparatus for inspecting and punching a diffusion layer for water electrolysis according to embodiments of the present disclosure;

FIG. 3A illustrates a plan view of a first inspector according to embodiments of the present disclosure;

FIG. 3B illustrates a side view of a first inspector according to embodiments of the present disclosure;

FIG. 4A illustrates a side view of a second inspector according to embodiments of the present disclosure;

FIG. 4B is a view illustrating a method for inspecting porosity according to embodiments of the present disclosure;

FIG. 5 is a view illustrating an example of marking according to embodiments of the present disclosure;

FIG. 6 is a drawing for describing an operation of a cutting machine according to embodiments of the present disclosure; and

FIG. 7 is a flowchart illustrating a method for inspecting and punching a diffusion layer for water electrolysis according to embodiments of the present disclosure.

### DETAILED DESCRIPTION

Hereinafter, some embodiments of the present disclosure are described in detail with reference to the exemplary drawings. In the drawings, the same reference numerals are used throughout to designate the same or equivalent elements. In addition, a detailed description of well-known features or functions has been omitted in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or to perform that operation or function.

Polymer electrolyte membrane water electrolysis (PEMWE) is a method of mainly using a cation exchange membrane to induce a hydrogen electrolysis (or water electrolysis) reaction by moving protons. The cation exchange membrane is used as an electrolyte and water is electrolyzed using the cation exchange membrane. In a PEMWE system, water (H₂O) is separated into hydrogen ions, oxygen gas, and electrons from an oxidation electrode (or an anode), and the hydrogen ions react with electrons generated after passing through the polymer electrolyte membrane and moving to a reduction electrode (or a cathode) to produce hydrogen gas.

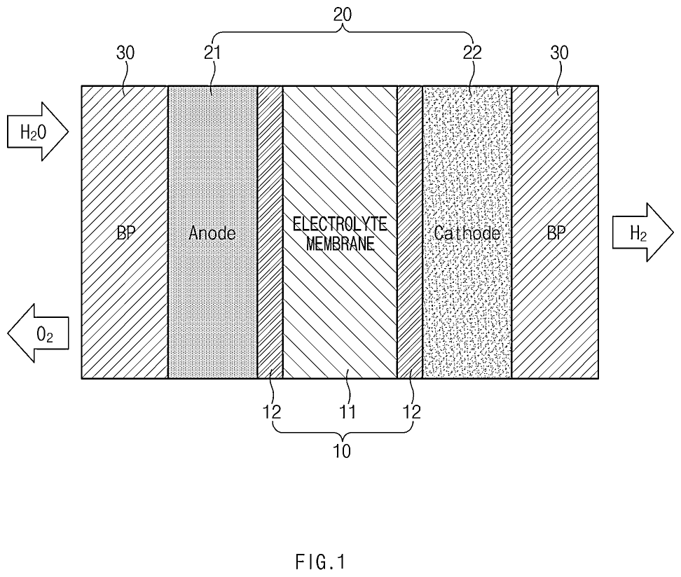

FIG. 1 is a drawing illustrating a structure of a PEMWE cell associated with the present disclosure.

A PEMWE system may include a stack including a plurality of unit cells. The unit cell may include a membrane electrode assembly (MEA) 10, a diffusion layer 20, a bipolar plate (BP) 30.

The MEA 10 may include a polymer electrolyte membrane 11 and an electrode catalyst 12. The MEA 10 may generate oxygen (O₂) gas (hereinafter referred to as “oxygen”) and hydrogen (H₂) gas (hereinafter referred to as “hydrogen”) by means of a water electrolysis reaction.

The diffusion layer 20 may move electrons and transport substances, and may include a porous transport layer (PTL) 21 and a gas diffusion layer (GDL) 22.

The PTL 21 may be located between the MEA 10 and the BP 30 to serve as an oxidation electrode (or a negative pole or an anode). The PTL 21 may deliver a reactant (e.g., water (H₂O)) required for a water electrolysis reaction to the MEA 10. Furthermore, the PTL 21 may deliver a product (e.g., hydrogen (H₂)) produced by the MEA 10 to the BP 30. The PTL 21 may be made of titanium (Ti).

The PTL 21 may be manufactured through a slurry manufacturing process, a molding process, a debinding process, and a sintering process. In the slurry manufacturing process, slurry may be manufactured by mixing 85 to 98 wt % of titanium powder, 3 to 8 wt % of ethanol, 1 to 3 wt % of a dispersant, and 1 to 4 wt % of a binder. In the molding process, the slurry may be molded through a powder metallurgy process, a tape casting process, a web process, an injection process, or the like. In the debinding process, a solvent except for titanium may be removed from a molded body through heat treatment at a low-temperature (e.g., 600° C. to 800° C.) in an argon (Ar) atmosphere. In the sintering process, the degreased molded body may be sintered through vacuum heat treatment at a high temperature (e.g., in range of 1000° C. to 1300° C.) in a vacuum degree in range of 10⁻⁶˜10⁻⁷ Torr or less.

The GDL 22 may provide a path where hydrogen produced by the water electrolysis reaction moves to the BP 30. The GDL 22 may be located between the MEA 10 and the BP 30 to serve as a reduction electrode (or a positive pole or a cathode).

The BP 30 may provide water and current to the MEA 10 and may discharge oxygen (O₂) and hydrogen produced in the water electrolysis reaction. The BP 30 located at an external side of the PTL 21 may supply water to the MEA 10 and may discharge oxygen produced by the water electrolysis reaction in the MEA 10. The BP 30 located at an external side of the GDL 22 may discharge hydrogen produced by the water electrolysis reaction in the MEA 10.

The unit cell may include a gasket other than the MEA 10, the diffusion layer 20, and the BP 30. The gasket may serve to seal between the MEA 10 and the BP 30.

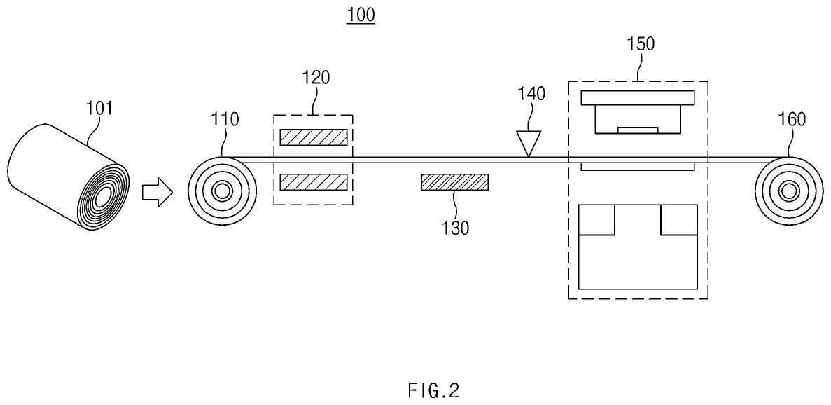

FIG. 2 is a drawing illustrating a configuration of an apparatus for inspecting and punching a diffusion layer for water electrolysis according to embodiments of the present disclosure.

An apparatus 100 for inspecting and punching a diffusion layer for water electrolysis may inspect (or examine) a thickness, porosity and/or pore uniformity of the diffusion layer applied to PEMWE. The apparatus 100 may punch the diffusion layer based on the inspected result to prepare a good product to be introduced for stack fastening. In a roll to roll (R2R) process, the apparatus 100 for inspecting and punching the diffusion layer may include an unwinder 110, a first inspector 120, a second inspector 130, a marker 140, a cutting machine 150, a rewinder 160, and a controller 170.

A PTL (or a PTL greensheet or a PTL film) 101 in roll form may be mounted on the unwinder 110. The unwinder 110 may unwind the PTL 101. Transport devices for transporting the PTL 101 may be provided between the unwinder 110 and the rewinder 160.

The first inspector 120 may inspect a thickness of the PTL 101 withdrawn by the unwinder 110. The first inspector 120 may measure the thickness of the PTL 101 using a sensor. The first inspector 120 may identify whether the measured thickness is identical to a predetermined target thickness within an error range.

The second inspector 130 may inspect porosity of the PTL 101 by measuring a weight of the PTL 101. The second inspector 130 may measure the weight of the PTL 101 using a weight sensor. The second inspector 130 may calculate porosity of the PTL 101 using the measured weight of the PTL 101 and a density of material of the PTL 101. The second inspector 130 may identify whether the measured porosity of the PTL 101 is identical to target porosity within an error range (e.g., ±5%).

The marker 140 may perform marking on one end surface (e.g., a lower surface) of the PTL 101 based on the results inspected by the first inspector 120 and the second inspector 130. When the thickness of the PTL 101 is greater than or less than the target thickness and/or when the porosity of the PTL 101 is greater than or less than the target porosity, the marker 140 may mark a predetermined mark (e.g., “pass” and “fail”) on the lower surface of the PTL 101. The marker 140 may mark “pass” and “fail” or may mark only “pass” or “fail”. The marker 140 may mark a production date, a lot number, and/or on the passed PTL 101.

The cutting machine 150 may cut the PTL 101 to a predetermined size using a photoelectric sensor. At this time, the cutting machine 150 may inspect pore uniformity of the PTL 101 using a sensor. The cutting machine 150 may determine whether to punch the PTL 101 based on the result of inspecting the pore uniformity of the PTL 101. When the pore uniformity of the PTL 101 is within a target pore uniformity range, the cutting machine 150 may punch the PTL 101. When the pore uniformity of the PTL 101 is out of the target pore uniformity range, the cutting machine 150 may not punch the PTL 101.

The cutting machine 150 may additionally consider the first inspector 120 and/or the second inspector 130 to determine whether to punch the PTL 101. In other words, the cutting machine 150 may determine whether to punch the PTL 101 based on the thickness, the porosity, and the pore uniformity of the PTL 101. For example, when the thickness, the porosity, and the pore uniformity of the PTL 101 pass all standards, the cutting machine 150 may determine to punch the PTL 101. Meanwhile, when at least one of the thickness, the porosity, or the pore uniformity of the PTL 101 does not pass the standards, the cutting machine 150 may determine not to punch the PTL 101.

The rewinder 160 may wind the PTL 101 passing through the cutting machine 150 with a certain tension. In other words, the rewinder 160 may rewind the PTL 101, the process of which is completed, in the form of a roll.

The components 110 to 160 may have communication circuits for transmitting and receiving data with each other, respectively. Furthermore, each of the components may include at least one processor for performing a given function and a memory. The at least one processor may be implemented as at least one of processing devices such as an application specific integrated circuit (ASIC), a digital signal processor (DSP), a programmable logic device (PLD), a field programmable gate array (FPGA), a central processing unit (CPU), a microcontroller, or a microprocessor. The memory may be a non-transitory storage medium which stores instructions executed by the at least one processor. The memory may be implemented as at least one of storage media such as a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), a register, a removable disk, or web storage.

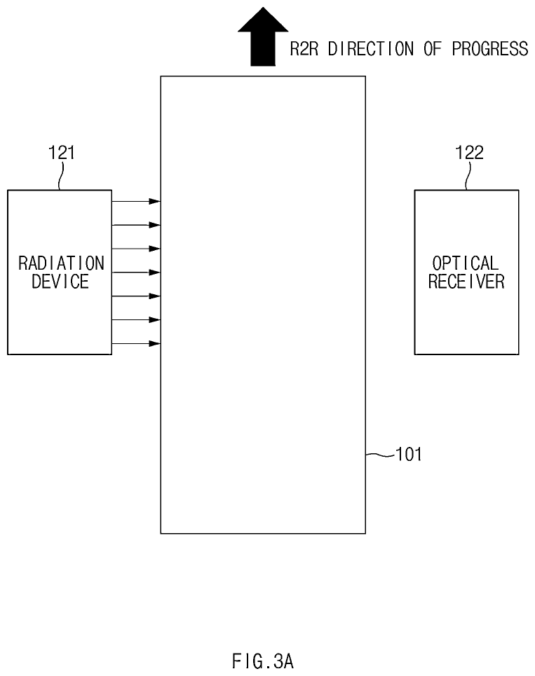

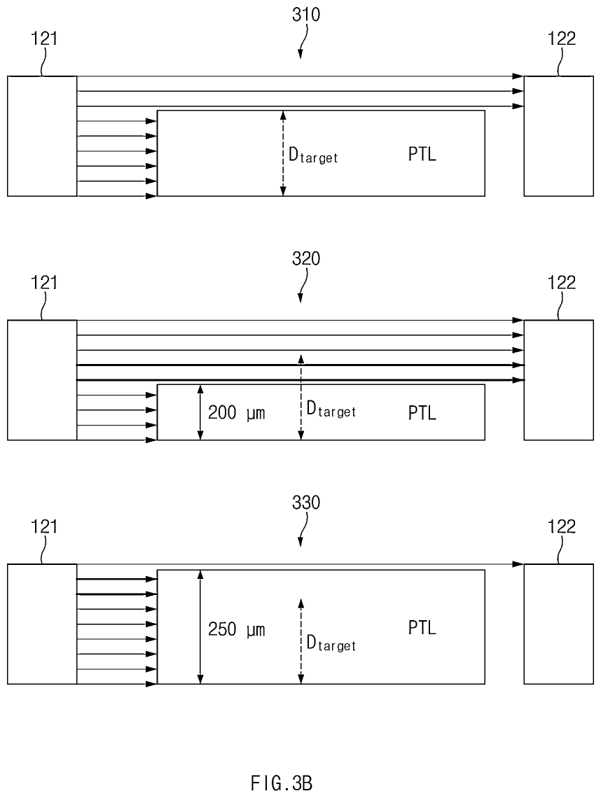

FIG. 3A illustrates a plan view of a first inspector according to embodiments of the present disclosure. FIG. 3B illustrates a side view of a first inspector according to embodiments of the present disclosure.

A first inspector 120 of FIG. 2 may inspect a thickness of a PTL 101 located between a radiation device 121 and an optical receiver 122 using the radiation device 121 and the optical receiver 122. The radiation device 121 and the optical receiver 122 may be arranged to face each other across a transport device which transports the PTL 101.

The radiation device 121 may radiate light using light sources which are spaced apart from each other at a predetermined interval (e.g., 50 μm). The light sources may radiate visible light or infrared light. The interval where the light sources are spaced apart from each other may be determined according to allowable thickness deviation (or a tolerance range).

The optical receiver 122 may detect light radiated from the radiation device 121 using photo sensors arranged at a predetermined interval. The photo sensors may be arranged symmetrically with the light sources. The optical receiver 122 may identify a location (or height) of a photo sensor which receives the radiated light and may measure a thickness of the PTL 101.

As an example, in a state where a target thickness D_{target} is set to 220 micrometers (μm) and the radiation device 121 radiates light by means of light sources that are located every 50 μm, if the optical receiver 122 cannot detect (or sense) light radiated from a light source located at 200 μm and can detect light radiated from a light source located at 250 μm, the first inspector 120 may determine that the thickness of the PTL 101 is within the allowable thickness deviation (or a design numerical range) from the target thickness. In other words, when it is determined that the thickness of the PTL 101 is suitable within the design numerical range, the first inspector 120 may determine “pass”. As the light sources are located every 50 μm, the allowable thickness deviation may be equal to or less than 50 μm.

As another example, when the optical receiver 122 detects light radiated from the light source located at 200 μm, the first inspector 120 may determine that the thickness of the PTL 101 is out of the allowable thickness deviation (e.g., less than “200 μm” as illustrated with “320” example in FIG. 3B). When it is determined that the thickness of the PTL 101 is out of the allowable thickness deviation from the target thickness (e.g., less than “200 μm”), the first inspector 120 may determine “fail”.

As another example, when the optical receiver 122 does not detect light radiated from the light source located at 250 μm, the first inspector 120 may determine that the thickness of the PTL 101 is greater than the target thickness with the allowable thickness deviation (e.g., greater than “200 μm” as illustrated with Example 330 in FIG. 3B). At this time, the first inspector 120 may determine the thickness of the PTL 101 as “fail”.

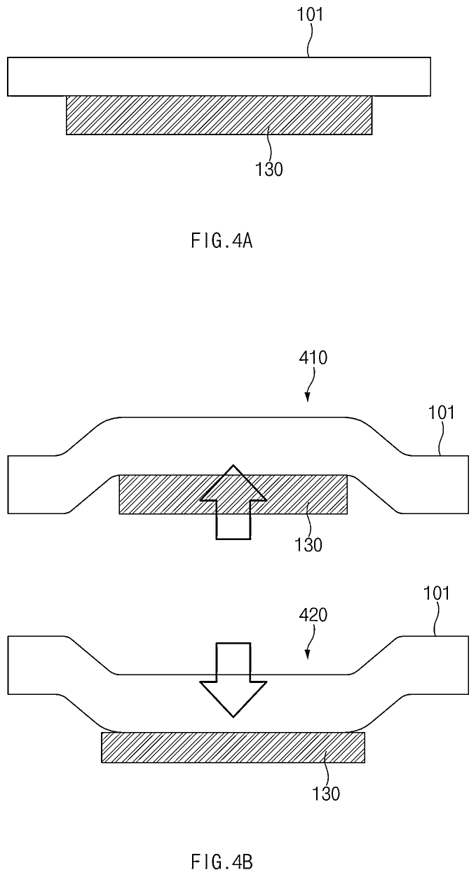

FIG. 4A illustrates a side view of a second inspector according to embodiments of the present disclosure. FIG. 4B is a drawing for describing a method for inspecting porosity according to embodiments of the present disclosure.

A second inspector 130 may measure a weight of a PTL 101 located on a weighing surface.

In one embodiment, the second inspector 130 may measure the weight of the PTL 101 located on the weighing surface while lifting the PTL 101 in a vertical direction with respect to the direction of transport of the PTL 101 (i.e., the R2R direction of progress) (410).

As another example, the second inspector 130 may measure the weight of the PTL 101 corresponding to an area of the weighing surface lowered while lowering a drive tension (420).

For example, when the area of the weighing surface with a width and length of 50 cm×50 cm is 2,500 cm² and when the thickness (or height) of the PTL 101 is 0.5 cm, a volume of the PTL 101 is 1,250 cm³. At this time, because titanium density is 4.5 g/cm³, the original weight of the PTL 101 should be 5,625 g (=1250 cm³×4.5 g/cm³). However, when the measured weight (or mass) is 3,937 g, the porosity of the PTL 101 may be calculated as 67% (=(3,937 g/5,625 g)×100%).

The second inspector 130 may identify whether the calculated porosity of the PTL 101 is within a design numerical range. The second inspector 130 may identify whether the calculated porosity of the PTL 101 is identical to target porosity within a tolerance range (e.g., ±5%). When the calculated porosity of the PTL 101 is within the design numerical range, the second inspector 130 may determine “pass” in porosity test. Meanwhile, when the calculated porosity of the PTL 101 is out of the design numerical range, the second inspector 130 may determine “fail” in porosity.

To reduce the number of measurements while increasing the reliability of measuring the porosity of the PTL 101, it is advantageous to have a larger area of the weighing surface of the second inspector 130, and a desirable area would be 1.5 m×3 m.

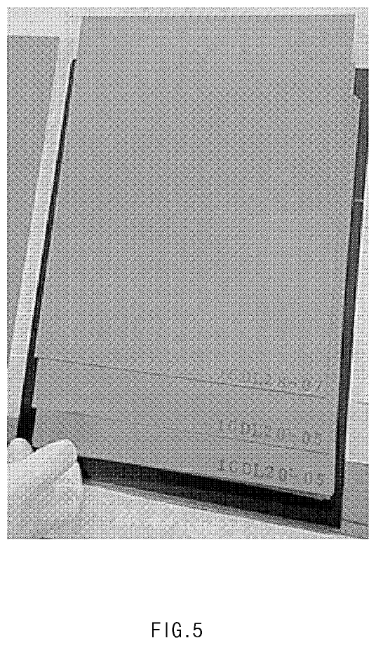

FIG. 5 is a drawing illustrating an example of marking according to embodiments of the present disclosure.

When there is at least one of when the thickness of a PTL is greater than or less than a design numerical value, when the porosity of the PTL is greater than or less than a target design numerical range, or a combination thereof, a marker 140 of FIG. 2 may mark a predetermined mark (e.g., a symbol, text, an image, or the like) on a lower surface of the PTL.

When “pass” is determined by a first inspector 120 and a second inspector 130 of FIG. 2, the marker 140 may mark a mark indicating “pass” on the lower surface of the PTL. When “fail” is determined by the first inspector 120 and/or the second inspector 130, the marker 140 may mark a mark indicating “fail” on the lower surface of the PTL.

Furthermore, the marker 140 may mark the mark indicating “fail” on only a PTL, “fail” of which is determined by the first inspector 120 and/or the second inspector 130.

Furthermore, the marker 140 may mark a production date, a lot number, and/or the like on only a PTL, “pass” of which is determined by the first inspector 120 and/or the second inspector 130.

The marker 140 may perform marking per specific distance with regard to the size of the PTL after being cut. An ink marking machine, a marking pad, a laser marking machine, or the like may be used as the marker 140.

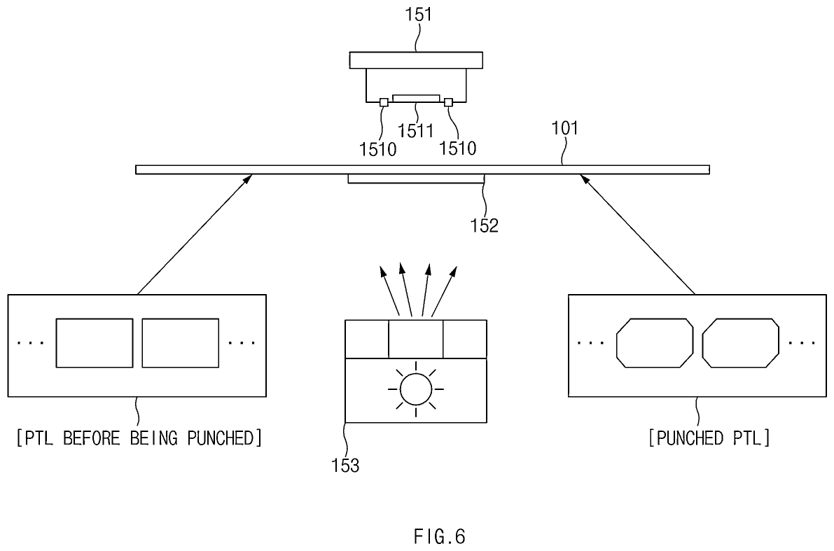

FIG. 6 is a drawing for describing an operation of a cutting machine according to embodiments of the present disclosure.

A cutting machine 150 of FIG. 2 may inspect pore uniformity of a PTL 101 and may determine whether to punch the PTL 101 based on the inspected result. Such a cutting machine 150 may include a punching part 151, a mounting part 152, and a light source part 153.

The punching part 151 may include a sensing part 1510 and a cutting blade 1511. Although not illustrated in the drawing, the punching part 151 may include a press part which applies a force to the PTL 101 when cutting the PTL 101.

The sensing part 1510 may sense a degree to which light radiated from the light source part 153 passes through the PTL 101 using light detectors.

The cutting blade 1511 may punch (or cut) the PTL 101 to a predetermined target size. The cutting blade 1511 may be located around a transparent plate with the target size. The cutting blade 1511 may be a jig plate integrally formed with a punching plate of the punching part 151. The case where the cutting blade 1511 is included in the punching part 151 is described in the present embodiment, but not limited thereto. The cutting blade 1511 may be included in the mounting part 152. For example, the mounting part 152 may include a transparent plate with a predetermined target size and a cutting blade which is located around the transparent plate to punch the PTL 101.

The mounting part 152 may serve as a bottom plate when the PTL 101 is punched. The mounting part 152 may be made of a transparent material such as acrylic, such that light radiated from the light source part 153 is transmitted. The mounting part 152 may enlarge or reduce an area where light is transmitted (or a light transmission area). The mounting part 152 may adjust the light transmission area depending on a density of the PTL 101. For example, when the density of the PTL 101 is high, the mounting part 152 may reduce the light transmission area to increase transmissivity of light. Meanwhile, when the density of the PTL 101 is low, the mounting part 152 may enlarge the light transmission area.

The light source part 153 may radiate light in the direction of the PTL 101 through the mounting part 152. The light source part 153 may radiate light in one direction or may radiate light in a plurality of directions using a concave lens.

The cutting machine 150 may radiate light to the PTL 101 by means of the light source part 153 and may sense light which reaches the sensing part 1510 through the mounting part 152 to measure a pore size of the PTL 101. The cutting machine 150 may identify a uniform degree (or pore uniformity) of the measured pore size of the PTL 101. When the pore uniformity of the PTL 101 is within a predetermined design numerical range, the cutting machine 150 may cut the PTL 101 to a target size using the cutting blade 1511 of the punching part 151. Meanwhile, when the pore uniformity of the PTL 101 is out of the design numerical range, the cutting machine 150 may fail to punch the PTL 101.

The PTLs 101 located spaced apart from each other at a certain interval may be continuously supplied to the cutting machine 150, or the PTL 101 in which continuous coating rather than pattern coating is performed on a sheet (or a film) may be supplied to the cutting machine 150. In a situation where the continuously coated PTL 101 is supplied, although the light source part 153 radiates light to the PTL 101 and the PTL 101 moves a certain distance by R2R equipment, when the sensing part 1510 does not sense light, the punching part 151 may apply a force to the PTL 101 to cut the PTL 101 to a desired size using the cutting blade 1511. When light of a criterion or more is sensed by the sensing part 1510 or when the pore size is not uniform, the cutting machine 150 may fail to cut the PTL 101.

When the PTL 101 is supplied, it may be always located in an R2R center (or the center of a roll width) using edge position control (EPC). The EPC may be defined as a function of sensing an edge of the PTL 101 using a sensor and sensing and aligning the transporting (or driving) of the PTL 101 in an R2R process. Meanwhile, the PTL 101 may be manufactured to be larger than the target size such that separate alignment is not required.

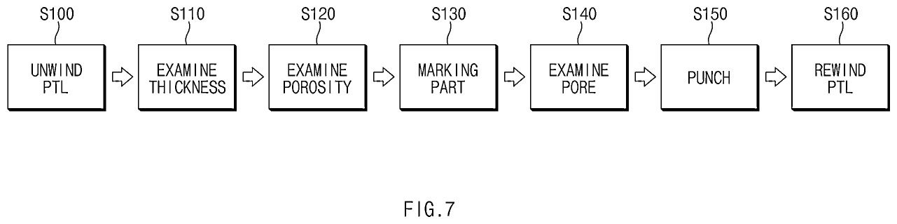

FIG. 7 is a flowchart illustrating a method for inspecting and punching a diffusion layer for water electrolysis according to embodiments of the present disclosure.

In operation S100, an apparatus 100 for inspecting and punching a diffusion layer for water electrolysis (hereinafter referred to as an “apparatus 100”) in FIG. 2 may unwind a PTL in roll form using an unwinder 110 of FIG. 2. The unwinder 110 may supply the unwound PTL to a first inspector 120 of FIG. 2.

In operation S110, the apparatus 100 may examine a thickness of the PTL using the first inspector 120. The first inspector 120 may radiate light to the PTL by means of a radiation device 121 of FIG. 3A and may measure a location where light is detected (or sensed) by an optical receiver 122 of FIG. 3A to inspect the thickness of the PTL. The apparatus 100 may identify whether the thickness of the PTL is within a design numerical range. The apparatus 100 may determine “pass” when the thickness of the PTL is within the design numerical range and may determine “fail” when the thickness of the PTL is out of the design numerical range.

In operation S120, the apparatus 100 may examine porosity of the PTL using a second inspector 130 of FIG. 2. The apparatus 100 may measure a weight of the PTL using a weight sensor. The apparatus 100 may calculate the weight of the PTL based on an area of a measurement plate for measuring weight, a density of material of the PTL, and the thickness of the PTL. The apparatus 100 may calculate the porosity of the PTL using the calculated weight of the PTL and the actually measured weight of the PTL. The apparatus 100 may identify whether the calculated porosity of the PTL is within a design numerical range. The apparatus 100 may determine “pass” when the calculated porosity of the PTL is within the design numerical range and may determine “fail” when the calculated porosity of the PTL is out of the design numerical range.

In operation S130, the apparatus 100 may perform marking on a one end surface of the PTL using a marker 140 of FIG. 2 based on the result (s) inspected by the first inspector 120 and/or the second inspector 130. When the PTL passes both the inspections of the first inspector 120 and the second inspector 130, the apparatus 100 may mark text, such as “pass”, a production date, and/or a lot number. Meanwhile, when the PTL is determined as “fail” by at least one of the first inspector 120, the second inspector 130, or a combination thereof, the apparatus 100 may mark a mark, such as text and/or a symbol indicating “fail”, on one end surface of the PTL.

In operation S140, the apparatus 100 may examine a pore of the PTL. In other words, the apparatus 100 may measure a uniform degree (or pore uniformity) of a pore size of the PTL using a sensing part 1510 and a light source part 153 of FIG. 6. The apparatus 100 may measure the amount of light which reaches the sensing part 1510 after light radiated from the light source part 153 passes through the PTL, thus inspecting pore uniformity of the PTL.

In operation S150, the apparatus 100 may punch the PTL based on the pore uniformity of the PTL. When the pore uniformity of the PTL is within a design numerical range, the apparatus 100 may control a punching part 151 of FIG. 6 to punch the PTL to a predetermined target size. Meanwhile, when the pore uniformity of the PTL is out of the design numerical range, the apparatus 100 may fail to punch the PTL.

In operation S160, the apparatus 100 may rewind the PTL passing through the punching process.

Thereafter, the apparatus 100 may exclude a PTL which is not cut and a PTL which is marked as “fail” as defective products and may put the other good products into stack fastening.

The case where only the PTL which is the good product is punched in the above-mentioned embodiments is presented, but not limited thereto. All PTLs may be punched to a target size and may be classified and stored into good products and defective products in a magazine.

Furthermore, a robot arm for dividing and classifying good products and defective products may be applied to the apparatus 100 for inspecting and punching the diffusion layer for water electrolysis.

Furthermore, the apparatus 100 for inspecting and punching the diffusion layer for water electrolysis may identify a good product and a defective product in a PTL greensheet as well as a PTL sintered product.

Embodiments of the present disclosure may inspect a thickness, porosity, and pore uniformity of a diffusion layer for water electrolysis and may punch the diffusion layer for water electrolysis depending on the inspected result, thus stabilizing the quality of the diffusion layer for water electrolysis to improve the performance and durability of a PEM water electrolysis system.

Furthermore, embodiments of the present disclosure may apply a roll to roll (R2R) process to automatically perform inspection and punching, thus reducing man per hour (M/H).

Hereinabove, although the present disclosure has been described with reference to exemplary embodiments and the accompanying drawings, the present disclosure is not limited thereto, but may be variously modified and altered by those having ordinary skill in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for inspecting and punching a diffusion layer for water electrolysis, the apparatus comprising:
a first inspector configured to inspect a thickness of the diffusion layer for water electrolysis;
a second inspector configured to inspect porosity of the diffusion layer for water electrolysis; and
a cutting machine configured to:
inspect pore uniformity of the diffusion layer for water electrolysis; and
cut the diffusion layer for water electrolysis based on a result of inspecting at least one of the thickness, the porosity, the pore uniformity, or a combination thereof.

2. The apparatus of claim 1, wherein the diffusion layer for water electrolysis is a porous transport layer (PTL) with a titanium material.

3. The apparatus of claim 1, wherein the first inspector includes:
a radiation device configured to radiate visible light or infrared light at a predetermined spacing; and
an optical receiver configured to receive the visible light or the infrared light, and
wherein the first inspector is configured to measure a location where the visible light or the infrared light is received by the optical receiver.

4. The apparatus of claim 1, wherein the second inspector is configured to:
measure a weight of the diffusion layer for water electrolysis;
calculate a weight of the diffusion layer for water electrolysis based on an area of a weighing surface, the thickness, and a density of material of the diffusion layer for water electrolysis; and
calculate the porosity using the calculated weight and the measured weight.

5. The apparatus of claim 1, further comprising:
a marker configured to mark the result inspected by the first inspector, the second inspector, or a combination thereof on one end surface of the diffusion layer for water electrolysis.

6. The apparatus of claim 1, wherein the cutting machine is configured to inspect a uniform degree of a pore size of the diffusion layer for water electrolysis using light where light radiated to the diffusion layer for water electrolysis passes through the diffusion layer for water electrolysis.

7. The apparatus of claim 1, wherein the cutting machine is configured to:
punch the diffusion layer for water electrolysis to a predetermined target size, when the pore uniformity is within a predetermined design numerical range; and
fail to punch the diffusion layer for water electrolysis, when the pore uniformity is out of the predetermined design numerical range.

8. A method for inspecting and punching a diffusion layer for water electrolysis, the method comprising:
inspecting at least one of a thickness of a diffusion layer for water electrolysis, porosity of the diffusion layer for water electrolysis, pore uniformity of the diffusion layer for water electrolysis, or a combination thereof; and
cutting the diffusion layer for water electrolysis based on a result of inspecting the at least one of the thickness, the porosity, the pore uniformity, or the combination thereof.

9. The method of claim 8, wherein the diffusion layer for water electrolysis is a porous transport layer (PTL) with a titanium material.

10. The method of claim 8, wherein inspecting includes:
radiating visible light or infrared light at a predetermined spacing; and
measuring a location where the visible light or the infrared light is received.

11. The method of claim 8, wherein inspecting includes:
measuring a weight of the diffusion layer for water electrolysis;
calculating a weight of the diffusion layer for water electrolysis based on an area of a weighing surface, the thickness, a density of material of the diffusion layer for water electrolysis; and
calculating the porosity using the calculated weight and the measured weight.

12. The method of claim 8, further comprising:
marking the result of inspecting at least one of the thickness, the porosity, or a combination thereof on one end surface of the diffusion layer for water electrolysis.

13. The method of claim 8, wherein inspecting includes:
radiating light to the diffusion layer for water electrolysis; and
inspecting a uniform degree of a pore size of the diffusion layer for water electrolysis using light passing through the diffusion layer for water electrolysis.
